(19) United States
(12) Patent Application Publication
(10) Pub. No.: US 2013/0036658 A1
(43) Pub. Date: Feb. 14, 2013

(54) Rodent Snap Trap

(71) Applicant: Anthony J. Bayne, Lomita, CA (US)

(72) Inventor: Anthony J. Bayne, Lomita, CA (US)

(21) Appl. No.: 13/237,895

(22) Filed: Sep. 20, 2011

Related U.S. Application Data
(60) Provisional application No. 61/523,279, filed on Aug. 13, 2011.

(51) Int. Cl. A01M 23/30; A01M 23/00

(52) U.S. Cl. 43/81; 43/58

(57) ABSTRACT

A rodent snap trap device includes a pressure sensitive adhesive material of a removable type disposed on the top surface the first operative half of the device, inside the inner perimeter of the snap bar when the device is non-loaded. A rodent that steps through an aperture in the bait pedal and/or onto the adhesive material will react by pulling away, jostling the catch free of the rod to set off the snap trap.

### RELATED APPLICATION

This application is based on and claims priority to U.S. Provisional Patent Application No. 61/523,279 filed 08-13-2011, the entire disclosure is hereby incorporated by reference.

### BACKGROUND OF THE INVENTION

1. Field of Invention

The invention relates generally to pest control, and more specifically an improved rodent snap trap.

2. Description of the Related Technology

Prior art rodent traps include a “snap trap”. A snap trap has a snap bar rotatably coupled to a base. The snap bar is biased to a default position by a spring disposed centrally on the base. In this default position, the snap bar defines the area where a rodent may be captured or killed when the trap has sprung.

One such exemplary prior art rodent trap is the VICTOR® trap provided by Woodstream Corp. The trigger mechanism in such a trap consists of two separate components: a rod and a lever. The lever further comprises a catch, and a bait pedal. To set the trap, the snap bar is rotated against the bias of the spring to a nearly horizontal position adjacent to a first end of the base. A first end of the rod is secured to the first end of the base. The rod is maneuvered over the top of the rotated snap bar. The opposite, free end of the rod is then manually engaged with the catch to hold the snap bar in place until a rodent exerts enough force on the lever to disengage the catch from the rod.

Another popular type of rodent trap is a “glue trap”. A glue trap may be made of a flat, rectangular plastic or cardboard base, covered with a layer of an adhesive material. It may be baited and/or placed in a rodent's pathway. A rodent that runs across the glue trap will be held to the glue trap's surface. The trap can be disposed of with the rodent attached.

A major drawback with rodent snap traps, according to the prior art, is that a rodent with a light touch may take the bait off of a baited trap without springing the trap. This may happen when the rodent does not exert sufficient force on the lever to disengage the catch. Another major drawback is that a very fast rodent, a la “Speedy Gonzales”®, may be able to get the bait and escape before the snap bar can catch the rapid rodent.

A major drawback of glue traps, according to the prior art, is that a rodent trapped by the glue may die slowly on the trap, or severely injure itself (e.g. gnaw off a paw) to get free. Many view this as an inhumane method of catching a rodent.

### SUMMARY OF CERTAIN INVENTIVE ASPECTS

In accordance with the present invention, an apparatus is disclosed to overcome the deficiencies in the prior art.

In one aspect, an apparatus comprising a snap bar rodent trap and a pressure sensitive adhesive material of a removable type.

In another aspect, an upgrade kit for a rodent snap trap device, comprising an unattached adhesive sheet, including adhesive material on a top surface of the sheet, and the sheet further being attachable to a rodent snap trap.

In another aspect, a rodent terminating device, comprising a base having a first end and a second end, a snap bar pivotally coupled to the base, the snap bar being configured to rotate between a first default position adjacent to the first end of the base and a second loaded position adjacent to the second end of the base, the snap bar being spring biased toward the first position, the snap bar having at least one axial section and one transverse section, a rod, a catch configured to releasably engage the rod and hold the snap bar in the second loaded position and a bait pedal including an aperture configured to receive a rodent's paw.

In another aspect, an apparatus comprising an adhesive material of a removable type and a means to terminate a rodent. The means to terminate being separate and distinct from the means to delay.

The invention, now having been briefly summarized, may be better visualized by turning to the following drawings wherein like elements are referenced by like numerals. While the invention will be discussed in the context of a snap trap, it is to be understood that the invention includes other rodent traps that rely on a rodent putting pressure on a trigger mechanism to set-off the trap (e.g. a mouth-type trap).

### BRIEF DESCRIPTION OF THE DRAWINGS

FIG. 1 is a perspective view of a preferred embodiment of a rodent trap device according to the invention;

FIG. 2 is an external top view of a snap trap device including a bait well and a bait pedal, the bait pedal including a plurality of apertures in a preferred configuration that encircles the bait well when the device is in a loaded position.

FIG. 3 is an external top view of an alternate embodiment of a rodent trap device, including a bait pedal without an aperture to receive a rodent's paw and an adhesive material that is disposed within the inner perimeter of the snap bar when it is in a non-loaded position;

FIG. 4A is a side view of a bait pedal including a separating means that prevents the bait pedal from contacting an adhesive material disposed on top of the base;

FIG. 4B is a side view of a bait pedal including a separating means that comprises a downward bending edge that prevents the bait pedal from contacting an adhesive material disposed on top of the base;

FIG. 4C is a side view of bait pedal that rests on the top surface of the base when the trap is non-loaded so that the bait pedal does not contact adhesive material that is disposed in the base;

FIG. 5A-5C illustrate a top, side and bottom view of an unattached adhesive sheet, including a bare patch and an adhesive material on a top and bottom surface.

FIG. 6A-6B illustrates external views of an alternate embodiment of an adhesive material disposed on a top surface of a snap trap device, the adhesive material further including an area to receive a bait pedal.

FIG. 7 is a perspective view of an alternate embodiment of a lever, comprising a first top level and a second level that is below the first level. The first level includes an aperture to receive a rodent's paw and the second level includes an adhesive material for the rodent to step on.

### DETAILED DESCRIPTION OF THE PREFERRED EMBODIMENTS AND THE BEST MODE OF INVENTION

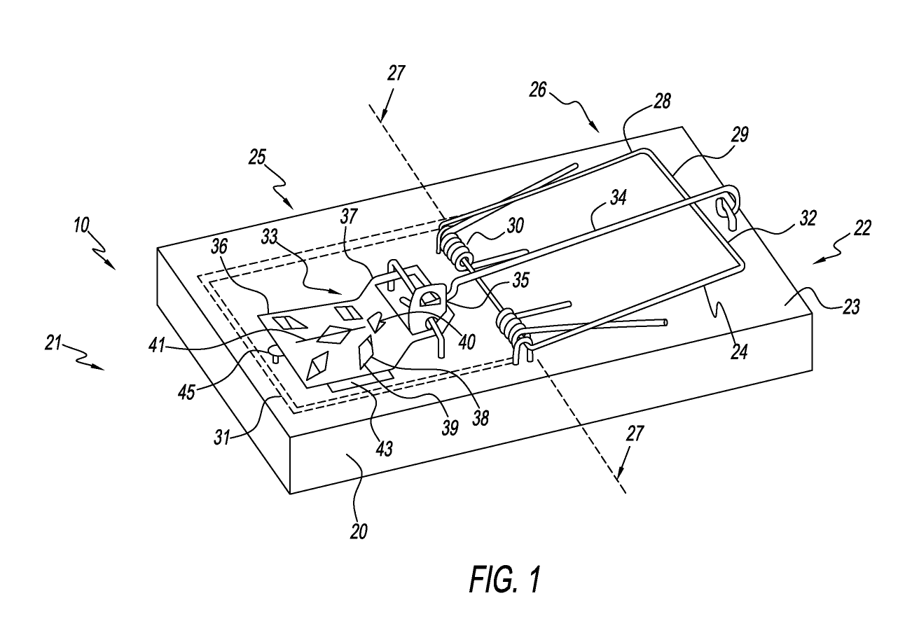

FIG. 1 is a perspective view of a preferred embodiment of a rodent snap trap, or device, 10. The device 10 comprises a base 20 having a first end 21, a second end 22 and a top surface 23. A snap bar 24 is rotatably coupled, or anchored, to a central portion of the top surface 23 of the base 20, thereby dividing the top surface 23 into a first operative half 25 and a second, loading, or non-operative half 26. The points of pivot of the snap bar 24 to which the bar 24 is coupled to the base 20 define a transverse dividing line 27 that divides the base 20 into the operative half 25 and non-operative half 26. The snap bar 24 comprises a pair of axial sections 28 joined by a transverse section 29. Springs 30 bias the snap bar 24 to an non-loaded position 31 as indicated by phantom lines in FIG. 1. The snap bar 24 is thus rotatable between a first rest position 31 and a second loaded position 32 as described further below.

In the first rest position 31 shown in FIG. 1, the snap bar 24 lies in the first operative half 25 of the base 20 and defines a perimeter of a rodent kill or capture zone, where any rodent disposed therein will get caught by the snap bar 24 upon snapping.

In a preferred embodiment, the device 10 comprises a rodent snap trap, including a lever 33 and a rod 34. The lever 33 further comprises a catch 35 to engage the rod 34 and a bait pedal 36.

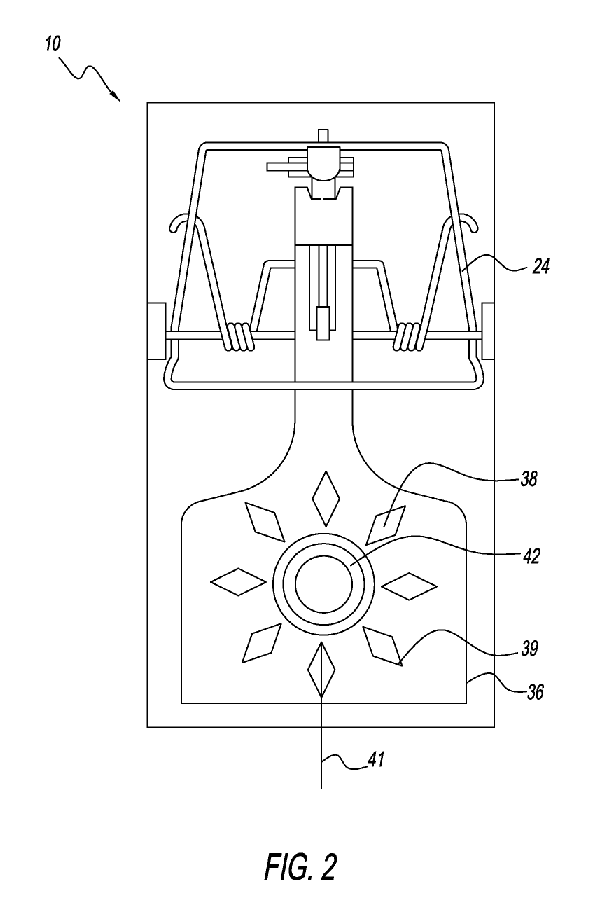

In a preferred embodiment, the lever 33 is a unitary piece, the catch 35 integral to the bait pedal 36 being connected by a downwardly inclined stem 37. In an alternative embodiment, the catch 35 and/or bait pedal 36 may be a different suitable configuration. For example, instead of a device 10 that uses a rod 34 and catch 35 to hold a snap bar 24 in a loaded position 32, the invention may be used for a device 10 (FIG. 2) that does not use a rod 34 to hold a snap bar 24 in a loaded position 32 (e.g. VICTOR® “power kill trap”).

In a preferred embodiment, the bait pedal 36 is substantially horizontal to the top surface 23 of the base 20 when the catch 35 is engaged with the rod 34 to hold the snap bar 24 in a loaded position 32. The bait pedal 36 may be of any suitable shape (e.g. spatula, rectangular, etc.) and size.

In a preferred embodiment, the bait pedal 36 will have at least one aperture 38 substantially aligned over an adhesive material 43. The aperture 38 is further configured to receive a rodent's paw. In an alternate embodiment, the bait pedal 36 may have no aperture 38. In a further alternate embodiment, the aperture 38 may not be aligned (substantially or otherwise) over an adhesive material 43. In yet another alternate embodiment, an indentation or recess in the surface of the bait pedal 36 may be used instead of, or in addition to an aperture 38 to receive a rodent's paw.

In a preferred embodiment, the aperture 38 will have at least one acute angle 39 that is generally pointed away from a bait holder 40 to temporarily catch a heel of a rodent that has stepped through the aperture 38 on its way to the bait holder 40 and then pulls it's paw back. The rodent's pulling will jostle the catch 35 from the rod 34 springing the snap bar 24. In an alternate embodiment, the aperture 38 may have no acute angle 39 (e.g. the aperture 38 is a circular shape, oblong shape, square shape, etc.). Likewise, a rodent exerting sufficient pressure on the lever 33 will disengage the rod 34 from the catch 35 and spring the device 10.

Further, the longitudinal axis 41 of the aperture 38 will generally be pointed toward the bait holder 40, so that the aperture's 38 length is in a pathway to the bait holder 40. It should be understood as used herein, a “bait holder” 40 includes a “bait well” 42 (as shown in FIG. 2) and other means (e.g. bait spike) to secure bait on a rodent snap trap device 10.

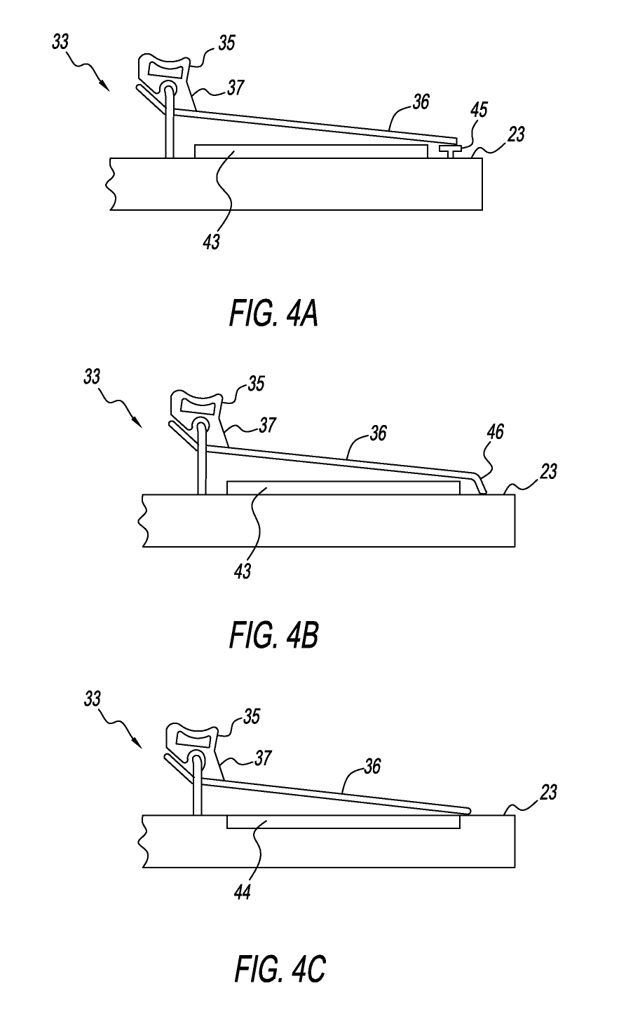

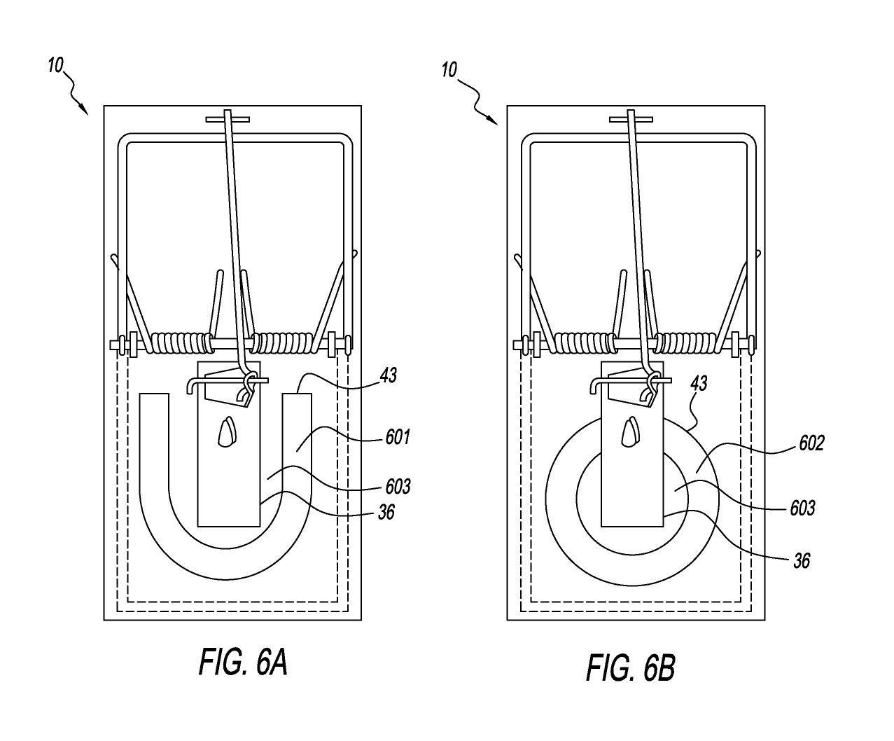

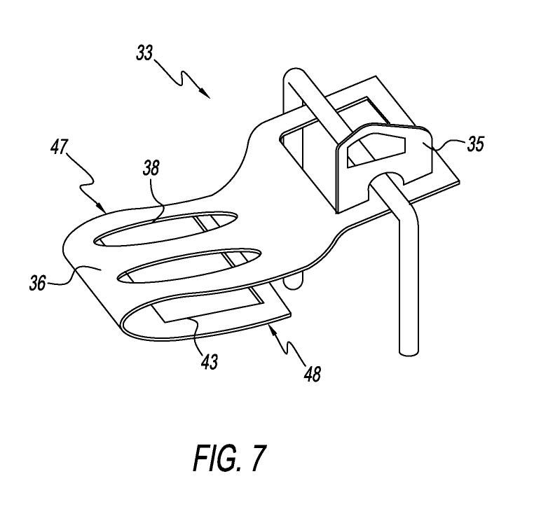

In a preferred embodiment, the device 10 will include an adhesive material 43 disposed on the top surface 23 operative half 25 of the device 10 inside the inner perimeter of the snap bar 24 when the device 10 is non-loaded 31 (as indicated by the phantom lines). The location of the adhesive material 43 insures that a rodent who pulls from the adhesive material 43 has positioned itself in the path of the snap bar 24. When the bait pedal 36 has at least one aperture 38, the adhesive material 43 may be disposed at least partially under the aperture 38. In an alternate embodiment, the adhesive material 43 may be disposed in 44 the top surface 23 of the base 20 (as shown in FIG. 4C), or on a different suitable surface (e.g. in the bait pedal 36 as shown in FIG. 7) or location of the device (e.g. not under the bait pedal 36 as shown in FIGS. 6A & 6B).

In a preferred embodiment, the adhesive material 43 will be a pressure sensitive adhesive of a removable type. For example, a pressure sensitive adhesive used for human skin contact may be used (e.g. medical tape in wound care dressings, Ashland's Aroset™ acrylic pressure sensitive adhesive, etc.). As used herein, the term “removable type” includes repositionable type adhesive material, such as the kind used in paper label applications (e.g. Post-It® notes, DOW's ROBOND™ PS-8061, etc.).

In an alternate embodiment, another suitable adhesive material 43, or combination of them, of a natural or synthetic type may be used (e.g. rubber-based, acrylic, modified acrylic, a silicone formulation, liquid, epoxy, glue, etc.). Properties of adhesives are well known by those of ordinary skill in the art, and so will not be discussed in greater detail.

When the adhesive material 43 is beneath the bait pedal 36, a separating means 45 (e.g. a staple) disposed at least partially beneath the bait pedal 36 may be used to prevent the bait pedal 36 from coming into contact with the adhesive material 43 when the device 10 is in a non-loaded position 31. The separating means 45 solves the problem of a bait pedal 36 coming into contact with and becoming stuck on the adhesive material 43 (e.g. glue).

When a pressure sensitive adhesive material 43 of a removable type is used, a rodent will be able to pull off of the adhesive material 43 without sustaining significant injury from the adhesive material 43.

When a rodent (not shown) steps through an aperture 38 of the bait pedal 36 and/or onto the adhesive material 43, the rodent will react by pulling away, jostling the device 10 and causing the catch 35 to disengage from the rod 34 springing the snap bar 24. Further, the adhesive material 43 will delay the rodent on the operative half 25 of the device 10 for the snap bar 24 (or the “teeth” of a mouth-type trap) to capture the rodent. Further, when the adhesive material 43 is on a surface other than the bait pedal 36 (e.g. the top surface 23), the adhesive material 43 will provide another means for a rodent to disengage a catch 35 and spring the device 10. This is an advantage over prior art snap traps that rely solely on a rodent putting pressure on the lever 33 to disengage the catch 35. The device 10 may include a removable cover (e.g. release paper, plastic sleeve, etc.) disposed on or over the adhesive material 43 to protect it from becoming soiled, or sticking to something accidentally.

FIG. 2 shows an external top view of an alternate embodiment of a device 10 including a bait well 42. The bait pedal 36 includes a preferred configuration of a plurality of apertures 38 that encircle the bait well 42 when the device 10 is loaded 32. In a preferred embodiment, the aperture(s) 38 will include at least one acute angle 39 pointing away from the bait well 42 when the device 10 is loaded 32, and a longitudinal axis 41 pointed in the general direction of the bait well 42 when the device 10 is loaded 32.

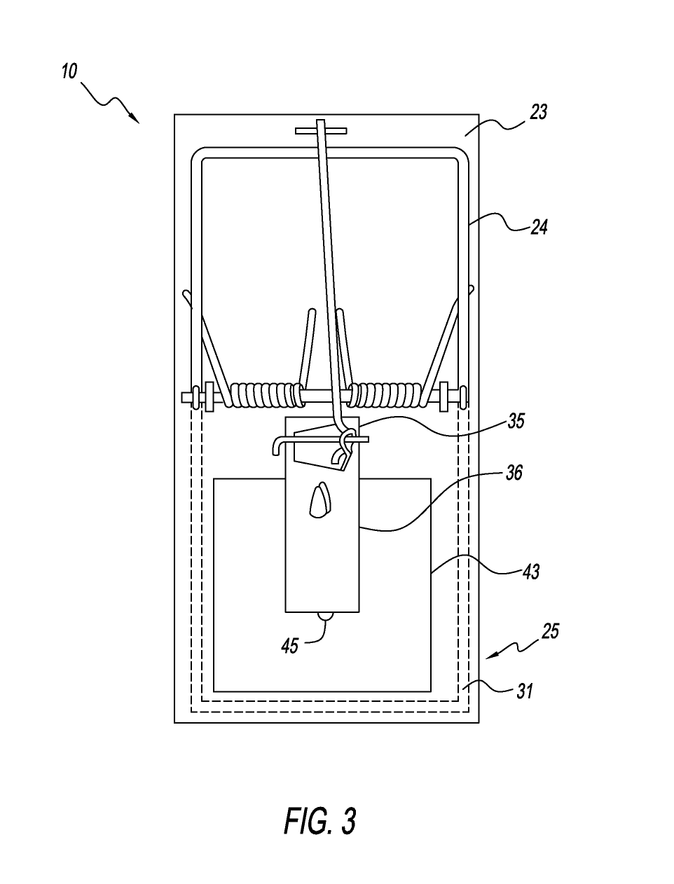

FIG. 3 shows a top external view of an alternate embodiment of a snap trap device 10, including a bait pedal 36 without an aperture 38. Adhesive material 43 is disposed on the top surface 23 in the first operative half 25 of the device 10 and inside the inner perimeter of the snap bar 24 when the device 10 is non-loaded 31 (as indicated by the phantom lines). A separating means 45 prevents the bait pedal 36 from contacting the adhesive material 43.

FIG. 4A shows a separating means 45 disposed partially beneath the bait pedal 36 that prevents the bait pedal 36 from contacting the adhesive material 43.

FIG. 4B shows an alternate embodiment of a bait pedal 36 including a separating means 45 that includes a downward inclined edge 46 that prevents the bait pedal 36 from contacting the adhesive material 43.

FIG. 4C shows an alternate embodiment of a bait pedal 36 that rests on the top surface 23 when the device 10 is in a non-loaded position 31. The bait pedal's 36 length extends over the adhesive material 43 disposed in 44 the base 20, so that the bait pedal 36 does not contact the adhesive material 43.

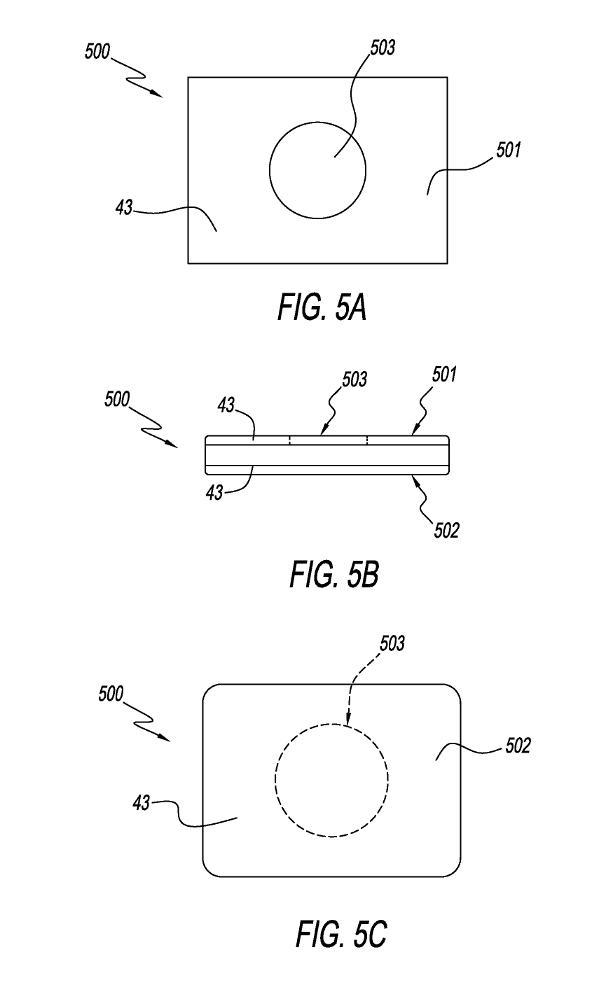

FIG. 5A-5C shows a top, side and bottom view of an alternate embodiment of an unattached adhesive sheet 500 (hereinafter “sheet”), including adhesive material 43 on a top surface 501 and a bottom surface 502. The sheet 500 may be sold with a device 10 as part of a “snap trap plus kit”, or separately as an “upgrade kit”, to enhance the effectiveness of a snap trap device 10. The adhesive material 43 may be covered with a detachable protective strip, or other suitable means, to prevent the adhesive material 43 from becoming soiled or stuck to something accidentally.

Providing an unattached sheet 500 will give a purchaser the option of increasing the effectiveness of the device 10 by attaching the sheet 500 to the top surface 23 first operative half 25 of the device 10. In a preferred embodiment, the sheet 500 includes adhesive material 43 on a top surface 501 and a bottom surface 502, so a purchaser can attach the sheet 500 to the top surface 23 of a device 10 by using the adhesive material 43 of either surface 501 or 502. In an alternative embodiment, the sheet 500 will include adhesive material 43 on one side only.

A separating means 45 may be used to affix the sheet 500 to the top surface 23 of the device 10. For example, an upgrade kit may be sold with a separating means 45 (e.g. a tack) that can be pushed through the sheet 500 to attach the sheet 500 to the top surface 23 of the device 10. Further, the separating means 45 may be attached in such a way that it is at least partially beneath the bait pedal 36, to prevent the bait pedal 36 from coming into contact with the sheet 500 (e.g. prevent the bait pedal 36 from accidentally getting stuck to the adhesive material 43).

The sheet 500 may include a bare area 503 that has no adhesive material 43 on it. In this embodiment, the bait pedal 36 may rest directly on the bare area 503, so that the bait pedal 36 does not contact the adhesive material 43. Alternatively, an area of the sheet 500 may be covered (e.g. by a piece of plastic, paper, etc.) to prevent the bait pedal 36 from contacting the adhesive material 43.

When the sheet 500 is double sided with adhesive material 43, each side 501 & 502 may be of the same type of adhesive material 43. Alternatively, each side 501 & 502 may be of a different adhesive material 43 type. When each side 501 & 502 is of a different adhesive material 43 type (e.g. glue on the top side 501 and a pressure sensitive adhesive of a removable type on the bottom side 502), the purchaser will have the option of choosing between tack strength. So, for example, the purchaser can choose to attach the sheet 500 pressure sensitive adhesive of a removable type 502 face up, so that a rodent may be able to pull off of the device 10 without significant injury from the adhesive material 43.

The sheet 500 may be sold in a variety of different sizes and shapes to allow for differences in device 10 sizes and configurations (e.g. a size to fit within the inner perimeter of the snap bar 24 when in an non-loaded position 31). In an alternate embodiment, the sheet 500 may come perforated or un-perforated, so that a purchaser can separate and/or cut the sheet 500 to fit a device 10 (e.g. cut to fit within the perimeter of the snap bar 24 when the device is in an non-loaded position 31).

FIGS. 6A & 6B illustrate alternate embodiments of adhesive material 43 that is not beneath a bait pedal 36. FIG. 6A illustrates adhesive material 43 in a “U-shaped”configuration 601. FIG. 6B illustrates adhesive material 43 in an “O-shaped” configuration 602. In these alternate embodiments, the shape of the adhesive material 43 includes an area 603 to accommodate a bait pedal 36, so the bait pedal 36 does not come into contact with the attached adhesive material 43. In an alternate embodiment, other suitable configurations (e.g. “V-shaped”, “L-shaped”, number shapes, dots, etc.) may be used.

FIG. 7 shows an alternate embodiment of a lever 33, including a first level 47 and a second level 48. In a preferred embodiment the first level 47 is integral to and above the second level 48. The first level 47 includes a catch 35, a bait pedal 36 and at least one aperture 38. The second level 48 includes an adhesive material 43 that is at least partially disposed beneath the at least one aperture 38 of the first level 47.

The disclosed invention teaches a new way to spring a snap trap by using a rodent's quick reflexes against it, so that the rodent's reaction of pulling away from the adhesive material jostles the catch free of the rod to set off the snap trap. Also, unlike prior art “glue traps”, the pressure sensitive adhesive material of a removable type of the present invention does not trap a rodent to the device, but instead delays the rodent for the spring bar to catch the rodent. Also, in using a pressure sensitive adhesive material of a removable type, the invention discloses a more humane trap, so if the device was sprung (e.g. by a first rodent) and a second rodent were to come along and step on the adhesive material to get any remaining bait, the second rodent would be able to successfully pull its paw off the adhesive material without significant harm.

Many alterations and modifications may be made by those having ordinary skill in the art without departing from the spirit and scope of the invention.

Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An apparatus comprising:
a snap bar rodent trap; and
a pressure sensitive adhesive material of a removable type.

2. The pressure sensitive adhesive material of claim 1 further comprising an adhesive material of a repositionable type.

3. The pressure sensitive adhesive material of claim 1 further comprising glue.

4. The snap bar rodent trap of claim 1, further comprising means to prevent a bait pedal from coming into contact with the adhesive material.

5. An upgrade kit for a rodent snap trap device, comprising:
an unattached adhesive sheet including adhesive material on a top surface of the sheet, and
the sheet further being attachable to a rodent snap trap.

6. The sheet of claim 5, further comprising adhesive material on a bottom surface.

7. The adhesive material of claim 6, further including an adhesive material that is of a different type than the adhesive material on the top surface.

8. The adhesive material of claim 6, further including an adhesive material that is of the same type of adhesive material that is on the top surface.

9. The sheet of claim 5 further being disposed inside the inner perimeter of a snap bar of an unloaded rodent snap trap device, when the sheet is attached to the rodent snap trap device.

10. The sheet of claim 5 further comprising a pressure sensitive adhesive material of a removable type.

11. The sheet of claim 5 further comprising an adhesive material of a repositionable type.

12. The sheet of claim 5 further comprising glue.

13. The kit of claim 5, further comprising:
means to prevent a bait pedal from coming into contact with the sheet when the sheet is attached to a rodent snap trap.

14. The sheet of claim 5, further including an area to accommodate a bait pedal of a rodent snap trap device.

15. The sheet of claim 5, further including a bare patch.

16. A rodent terminating device, comprising:
a base having a first end and a second end,
a snap bar pivotally coupled to the base, the snap bar being configured to rotate between a first default position adjacent to the first end of the base and a second loaded position adjacent to the second end of the base, the snap bar being spring biased toward the first position, the snap bar having at least one axial section and one transverse section,
a rod,
a catch configured to releasably engage the rod and hold the snap bar in the second loaded position; and
a bait pedal including an aperture configured to receive a rodent's paw.

17. The device of claim 16, wherein the aperture is substantially aligned over an adhesive material.

18. The device of claim 16, further comprising means to prevent the bait pedal from coming into contact with an adhesive material disposed on the base.

19. The aperture of claim 16, further comprising a longitudinal axis that is pointed in the direction of a bait holder.

20. The aperture of claim 16, further comprising an acute angle, wherein the acute angle is pointed away from a bait holder.

21. The device of claim 16, wherein the bait pedal comprises two levels, a first level having an aperture, and a second level below the first level comprising an adhesive material.

22. An apparatus comprising:
an adhesive material of a removable type; and
a means to terminate a rodent.
